(19) United States
(12) Patent Application Publication
(10) Pub. No.: US 2010/0215630 A1
(43) Pub. Date: Aug. 26, 2010

(54) Plant-derived Protectants Against Ultraviolet Light

(75) Inventors: Buford Merle Shepard, Charleston, SC (US); Martin Shapiro, Apex, NC (US); Said Ali El-Salamouny, Giza (EG)

Correspondence Address: MYERS BIGEL SIBLEY & SAJOVEC, PO BOX 37428, RALEIGH, NC, 27627, US

(73) Assignee: Clemson University Research Foundation

(21) Appl. No.: 12/710,857

(22) Filed: Feb. 23, 2010

Related U.S. Application Data
(60) Provisional application No. 61/154,703, filed on Feb. 23, 2009.

(51) Int. Cl. A01N 63/02; A01N 63/04; A01P 1/00

(52) U.S. Cl. 424/93.461; 424/93.6; 424/93.5; 424/93.4

(57) ABSTRACT

The present invention relates to plant extracts and formulations and kits thereof that protect insect microbial agents against ultraviolet irradiation. The invention further relates to methods of treating plants that has been damaged by an insect and/or protecting plants against insect damage.

This application claims the benefit of U.S. Provisional Application No. 61/154,703, filed Feb. 23, 2009, the entire contents of which is incorporated by reference herein.

### STATEMENT OF GOVERNMENT SUPPORT

Aspects of this research were supported by United States Department of Agriculture grant number 2006-34287-17370. The U.S. Government has certain rights to this invention.

### FIELD OF THE INVENTION

The present invention relates to plant extracts and formulations and kits thereof that protect insect microbial agents against ultraviolet (UV) irradiation. The invention further relates to methods of treating and protecting plants against insect damage.

### BACKGROUND OF THE INVENTION

For more than 40 years scientists have been investigating the detrimental effects of sunlight upon the efficacy of insect pathogens. In the laboratory, investigators demonstrated that the UVB portion of the solar spectrum (i.e., 280-320 nm) was primarily responsible for inactivation and tested many UVB absorbers to increase the persistence of insect pathogenic viruses (Jaques, Misc. Publ. Entomol. Soc. Am. 3:99 (1977); Shapiro et al., Environ. Entomol. 12:982 (1983); Ignoffo et al., J. Invertebr. Pathol. 57:134 (1990); Ragaei, J. Appl. Entomol. 123:381 (2001); Mondragón et al., Commun. Agric. Appl. Biol. Sci. 72:543 (2007)). One of the most widely investigated and efficacious UV protectants has been a natural polyflavinoid (lignin), which is found in all vascular plants and trees. Since plants exhibit diverse biological activities, including UVB absorbance and sunlight protection (Rozema et al., J. Photochem. Photobiol. B 66:2 (2002); Schmitz-Hoerner et al., Phytochemistry 64:243 (2003)), research programs have studied plants as virus enhancers (Shapiro et al., J. Entomol. Sci. 42:84 (2007); Shapiro et al., J. Entomol. Sci. 42:426 (2007)), UV protectants (Shapiro et al., Biocont. Sci. Technol. 18:605 (2008)), and adjuvants for insect pathogenic viruses.

The present invention provides improved compositions and methods for UV protection of insect microbial agents.

### SUMMARY OF THE INVENTION

In one aspect, the present invention relates to methods of protecting an insect microbial agent against damage by ultraviolet irradiation, comprising contacting the insect microbial agent with an effective amount of a composition comprising an extract of a plant that provides protection against ultraviolet irradiation.

In another aspect, the invention relates to compositions for protecting an insect microbial agent against damage by ultraviolet irradiation, the composition comprising:
a) an aqueous extract of a plant that provides protection against ultraviolet irradiation;
b) an oil; and
c) an emulsifier.

A further aspect of the invention relates to a protected insect microbial agent composition, comprising:
a) an insect microbial agent;
b) an aqueous extract of a plant that provides protection against ultraviolet irradiation;
c) an oil; and
d) an emulsifier.

In one embodiment, the plant is selected from the group consisting of anise, astralagus, cilantro, cinnamon, cloves, dill, fenugreek, feverfew, kudzu, licorice, magnolia, marjoram, oregano, paprika, peppermint, popcorn tree, rosemary, sage, spearmint, skullcap, St. John's wort, sumac, tarragon, thyme, valerian, and any combination thereof.

In another embodiment, the plant is selected from the group consisting of cloves, dill, fenugreek, feverfew, kudzu, licorice, magnolia, marjoram, oregano, peppermint, rosemary, skullcap, spearmint, tarragon, thyme, and any combination thereof.

In a further embodiment, the plant is selected from the group consisting of kudzu, peppermint, skullcap, and any combination thereof.

The invention further relates to methods of treating a plant that has been damaged by an insect and/or protecting a plant against damage by an insect, comprising contacting the plant with a composition of the invention.

A further aspect of the invention relates to a kit for treating a plant that has been damaged by an insect and/or protecting a plant against damage by an insect, the kit comprising:

(a) a composition comprising an aqueous extract of a plant that provides protection against ultraviolet irradiation; and

(b) instructions for carrying out the method of treating a plant and/or protecting a plant against damage by an insect.

### BRIEF DESCRIPTION OF THE DRAWINGS

FIG. 1 shows the UV absorption profile of plant extracts.

### DETAILED DESCRIPTION OF THE INVENTION

The present invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment can be deleted from that embodiment. In addition, numerous variations and additions to the embodiments suggested herein will be apparent to those skilled in the art in light of the instant disclosure, which do not depart from the instant invention.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

### DEFINITIONS

As used herein, “a,” “an,” or “the” can mean one or more than one. For example, “a” cell can mean a single cell or a multiplicity or plurality of cells.

Also as used herein, “and/or” refers to and encompasses any and all possible combinations of one or more of the associated listed items, as well as the lack of combinations when interpreted in the alternative (“or”).

Furthermore, the term “about,” as used herein when referring to a measurable value such as an amount of a compound or agent of this invention, dose, time, temperature, and the like, is meant to encompass variations of ±20%, ±10%, ±5%, ±1%, ±0.5%, or even ±0.1% of the specified amount.

The term “consists essentially of (and grammatical variants), as applied to the compositions (extracts and formulations) of this invention, means a composition that consists of both the recited components and additional components that do not materially alter the ability of the composition to protect insect microbial agents against UV irradiation. The term “materially altered,” as applied to UV protection, refers to an increase or decrease in protection of at least about 50% or more as compared to the protection of a composition consisting of the recited components.

“Treat” or “treating” or “treatment” refers to any type of action that prevents or decreases the amount of damage to a plant that is caused by insects.

“Protect” or “protecting” or “protection” refers to any type of action that prevents or reduces, at least temporarily, damage to a plant that is caused by insects.

The present invention is based on the discovery that certain plant extracts provide excellent protection of insect microbial agents against UV irradiation. The increased survival time (delayed inactivation) of the insect microbial agents in the presence of the extracts of the invention increases the effectiveness of the agents in protecting plants against insect damage and/or treating plants that are being damaged by insects.

In one aspect the invention relates to methods of protecting an insect microbial agent against damage by ultraviolet irradiation, comprising contacting the insect microbial agent with an effective amount of a composition comprising an extract of a plant that provides protection against ultraviolet irradiation. The methods are effective to protect against any type of UV irradiation, including UVA, UVB, or a combination of UVA and UVB.

In one embodiment, the plant is selected from the group consisting of anise, astralagus, cilantro, cinnamon, cloves, dill, fenugreek, feverfew, kudzu, licorice, magnolia, marjoram, oregano, paprika, peppermint, popcorn tree, rosemary, sage, spearmint, skullcap, St. John's wort, sumac, tarragon, thyme, valerian, and any combination thereof.

In another embodiment, the plant is selected from the group consisting of cloves, dill, fenugreek, feverfew, kudzu, licorice, magnolia, marjoram, oregano, peppermint, rosemary, skullcap, spearmint, tarragon, thyme, and any combination thereof.

In a further embodiment, the plant is selected from the group consisting of kudzu, peppermint, skullcap, and any combination thereof.

The extract can be prepared from any part or combination of parts of the plant, including leaves, stems, seeds, and/or roots. In one embodiment, the extract is an aqueous extract. The extract can be prepared by blending plant parts and water to obtain an extract with a concentration of about 0.1% to about 60% plant:water (wt:wt), e.g., about 0.5% to about 45%, e.g., about 1% to about 30%. After the blending, the extract is filtered (e.g., through coarse cheese cloth) to remove large pieces. The extract can then be used as is or stored for later use (e.g., at about 4° C.).

In one embodiment of the invention, the aqueous extract is combined into a composition for immediate or later use. In one embodiment, the composition comprises the aqueous extract and an oil. In another embodiment, the composition comprises the aqueous extract and an oil. The oil can be any natural, synthetic, or fractionated oil that is effective in the formulation. Suitable oils include, without limitation, vegetable oils and hydrogenated vegetable oils such as safflower oil, castor oil, coconut oil, cottonseed oil, menhaden oil, palm kernel oil, palm oil, peanut oil, soybean oil, rapeseed oil, linseed oil, rice bran oil, pine oil, sesame oil, sunflower seed oil, hydrogenated safflower oil, hydrogenated castor oil, hydrogenated coconut oil, hydrogenated cottonseed oil, hydrogenated menhaden oil, hydrogenated palm kernel oil, hydrogenated palm oil, hydrogenated peanut oil, hydrogenated soybean oil, hydrogenated rapeseed oil, hydrogenated linseed oil, hydrogenated rice bran oil, hydrogenated sesame oil, hydrogenated sunflower seed oil, and any combination thereof. Oils also include lipophilic compounds and compositions having the same effect on the formulation as vegetable oils, including, without limitation, animal fats and oils, mineral oil, petrolatum, straight and branched chain hydrocarbons having from about 7 to about 40 carbon atoms, C₁-C₃₀ alcohol esters of C₁-C₃₀ carboxylic acids and of C₂-C₃₀ dicarboxylic acids, mono-, di- and tri-glycerides of C₁-C₃₀ carboxylic acids, alkylene glycol esters of C₁-C₃₀ carboxylic acids, propoxylated and ethoxylated derivatives of the foregoing materials, C₁-C₃₀ mono- and poly-esters of sugars and related materials, C₄-C₂₀ alkyl ethers of polypropylene glycols, C₁-C₂₀ carboxylic acid esters of polypropylene glycols, di-C₈-C₃₀ alkyl ethers, organopolysiloxane oils, dimethiconols, and polyalkylaryl siloxanes.

In one embodiment of the invention, the composition comprises the aqueous extract and an emulsifier. In certain embodiments, the composition comprises the aqueous extract, and oil, and an emulsifier. The emulsifier can be any natural or synthetic emulsifier that is effective in the formulation (e.g., forms a stable emulsion). Suitable emulsifiers include, without limitation, anionic, cationic, nonionic, and amphoteric surfactants, and combinations thereof. In one embodiment, the emulsifier is one or more phospholipids, e.g., lecithin (phosphatidylcholine), phosphatidylglycerol, phosphatidyl serine, etc. Suitable cationic surfactants include, without limitation, alkylamines, alkyl imidazolines, ethoxylated amines, quaternary alkylbenzyldimethylammonium salts, quaternary alkyl betaines, quaternary heterocyclic ammonium salts, quaternary tetraalkylammonium salts and combinations thereof. Suitable anionic surfactants include, without limitation, acylamino acids and their salts, including acylglutamates, acyl peptides, sarcosinates and taurates, carboxylic acids and their salts, including alkanoic acid and alkanoates, ester carboxylic acids and ether carboxylic acids, phosphoric acid esters and their salts, including acyl isethionates, alkylaryl sulfonates, and sulfosuccinates, and sulfuric acid esters, including alkyl ether sulfates, alkyl sulfates, and combinations thereof. Suitable amphoteric and zwitterionic surfactants include, without limitation, alkyl imino acetates, iminodialkanoates and aminoalkanoates, imidazolinium and ammonium derivatives, betaines, sultaines, hydroxysultaines, alkyl sarcosinates, and alkanoyl sarcosinates. Suitable nonionic surfactants include, without limitation, decyl polyglucoside, lauryl polyglucoside, ceteth-6, ceteth-10, ceteth-12, ceteareth-6, ceteareth-10, ceteareth-12, steareth-6, steareth-10, steareth-12, steareth-20, steareth-21, PEG-6 stearate, PEG-10 stearate, PEG-100 stearate, PEG-12 stearate, PEG-20 glyceryl stearate, PEG-80 glyceryl tallowate, PEG-10 glyceryl stearate, PEG-30 glyceryl cocoate, PEG-80 glyceryl cocoate, PEG-200 glyceryl tallowate, PEG-8 dilaurate, PEG-10 distearate, coconut alkyl N-methyl glucoside amide, polyethylene glycol 20 sorbitan monolaurate (Polysorbate 20), polyethylene glycol 5 soya sterol, Ceteareth-20, PPG-2 methyl glucose ether distearate, Ceteth-10, Polysorbate 80, cetyl phosphate, potassium cetyl phosphate, diethanolamine cetyl phosphate, Polysorbate 60, glyceryl stearate, polyoxyethylene 20 sorbitan trioleate (Polysorbate 85), sorbitan monolaurate, polyoxyethylene 4 lauryl ether sodium stearate, polyglyceryl-4 isostearate, hexyl laurate, PPG-2 methyl glucose ether distearate, and any combination thereof.

In certain embodiments of the invention, the composition can further comprise, singly or in any combination, additional components (adjuvants) that enhance the effectiveness of the formulation. In one embodiment, the composition further comprises a spreader-sticker component, e.g., a component that improves the ability of the composition to stick to target areas and spread. Examples include, without limitation, Coco-Wet, Weather Shield™, Turbo, and Hi-Yield®. In another embodiment, the formulation further comprises a virus enhancer (an agent that enhances the insecticidal activity of a virus), e.g., stilbene fluorescent brighteners (U.S. Pat. No. 5,124,149).

As used herein, the term “insect microbial agent” refers to any microbial organism, extract, or product which is detrimental to insects and can be used to treat plants that have insect damage and/or protect plants against insect damage. The insect microbial agent can be targeted against any insect of interest, e.g., insects that damage crops, such as coleopterans (beetles), lepidopterans (caterpillars), and mites. In one embodiment, the insect microbial agent is an insect virus, e.g., a baculovirus. Examples of suitable baculoviruses for use in the present invention include, without limitation, beet armyworm (Spodoptera exigua) nucleopolyhedrovirus (SeNPV), army fallworm (Spodoptera frugiperda) nucleopolyhedrovirus (SfNPV), African cotton leafworm (Spodoptera littoralis) nucleopolyhedrovirus (SpliNPV), oriental leafworm (Spodoptera litura) nucleopolyhedrovirus (SpltMNPV), gypsy moth (Lymantria dispar) nucleopolyhedrovirus (LdMNPV), cotton bollworm (Helicoverpa zea) nucleopolyhedrovirus (HzSANPV), cotton bollworm (Helicoverpa armigera) nucleopolyhedrovirus (HaSNPV), tobacco budworm (Helicoverpa virescens) nucleopolyhedrovirus (HvSNPV), celery looper (Anagrapha falcifera) nucleopolyhedrovirus (AfNPV), alfalfa looper (Autographa californica) nucleopolyhedrovirus (AcMNPV), codling moth (Cydia pomonella) granulosis virus (CpGV), cabbage moth (Mamestra brassicae) nucleopolyhedrovirus (SeMNPV), diamondback moth (Plutella xylostella) granulosis virus (PxGV), and any combination thereof. In one embodiment, the insect microbial agent is a bacterium, e.g., Bacillus thuringiensis. In one embodiment, the insect microbial agent is a fungus, e.g., Beauveria bassiana or Metarhizium anisopliae. In one embodiment, the insect microbial agent is a botanical, e.g., an extract from Azadirachta indica (e.g., neem). In one embodiment, the insect microbial agent is a microbial product, e.g., spintor. In one embodiment, the insect microbial agent is a nematode, e.g., Steinernema or Heterorhabditis species.

In the methods of the invention, the insect microbial agent is contacted with the composition in any manner effective to protect the agent against UV irradiation. In one embodiment, the insect microbial agent is coated with the composition. In another embodiment, the insect microbial agent is suspended in a liquid composition comprising the extract. The resulting insect microbial agent is a “protected insect microbial agent.”

Once the insect microbial agent has been contacted with the composition, the agent is applied to plants to be protected against insect damage and/or plants that are currently being damaged and/or have been damaged by insects. The protected insect microbial agent can be applied to the plants by any method known in the art to be effective, including spraying, pouring, dipping, in the form of concentrated liquids, solutions, suspensions, sprays, powders, pellets, briquettes, bricks and the like. The agent can be applied to the leaves of the plant, the base of the plant, and/or the soil around the plant. The protected insect microbial agent can be applied once or repeatedly, e.g., on a regular schedule (such as hourly, daily, every two days, weekly, monthly, seasonally, etc.) or on an as needed basis. The amount of protected insect microbial agent applied is sufficient to protect and/or treat the plants as is well known in the art. For example, for baculoviruses, the agent can be applied in an amount of about 10¹⁰ to about 10¹⁴ viral occlusion bodies/hectare, e.g., about 10¹¹ to about 10¹³ viral occlusion bodies/acre.

The protected insect microbial agent can be applied to any plant of interest, including agricultural crops, gardens, and forestry plants. Such plants include, without limitation, grains, fruits, and vegetables, such as to maize, rice, soybeans, canola, sunflower, alfalfa, sorghum, wheat, cotton, peanuts, tomatoes, potatoes, fruit trees, flowering trees, hardwoods, conifers, and the like.

One aspect of the invention relates to a composition for protecting an insect microbial agent against damage by ultraviolet irradiation, the composition comprising:
a) an aqueous extract of a plant that provides protection against ultraviolet irradiation; and optionally
b) an oil; and/or
c) an emulsifier.

The composition can be in any form suitable for administration to an insect, e.g., by oral ingestion, penetration through the cuticle, and/or penetration of the insect respiratory system. In one embodiment, the composition is a liquid. In other embodiments, the composition is a foam, gel, suspension, aerosol, or concentrate. In other embodiments, the composition is solid, such as a powder, granule, or dust. In another embodiment, the composition is an emulsion. In one embodiment, the composition comprises about 0.1% to about 90% aqueous extract (vol/vol), e.g., about 0.5% to about 50%, e.g., about 1% to about 30%, e.g., 1, 2, 3, 4, 5, 6, 7, 8, 9, 10, 15, 20, 25, 30, 35, 40, 45, 50, 55, 60, 65, 70, 75, 80, 85, or 90%. In one embodiment, the composition comprises about 0.1% to about 90% oil (vol/vol), e.g., about 0.5% to about 30%, e.g., about 1% to about 15%, e.g., 1, 2, 3, 4, 5, 6, 7, 8, 9, 10, 15, 20, 25, 30, 35, 40, 45, 50, 55, 60, 65, 70, 75, 80, 85, or 90%. In one embodiment, the composition comprises about 0.1% to about 90% emulsifier (vol/vol), e.g., about 0.5% to about 10%, e.g., about 1% to about 5%, e.g., about 1, 2, 3, 4, 5, 6, 7, 8, 9, 10, 15, 20, 25, 30, 35, 40, 45, 50, 55, 60, 65, 70, 75, 80, 85, or 90%.

In one embodiment, the composition further comprises additional components, singly or in any combination, e.g., components that enhance the activity and/or usability of the composition, e.g., sticker-spreaders, viral enhancers, UV stabilizers (such as carbon black, para-aminobenzoic acid (PABA)), UV blockers (e.g., titanium dioxide, zinc oxide), lignins (e.g., IMC-90001 or Shade®), carriers, diluents, dispersants, stabilizing agents, rheological agents, flow agents, fillers, flocculants, buffers, fragrances, odor masking agents, preservatives, antioxidants, bactericides, and bacteriostats in any combination.

One aspect of the invention relates to a protected insect microbial agent composition, comprising:
a) an insect microbial agent;
b) an aqueous extract of a plant that provides protection against ultraviolet irradiation; and optionally
c) an oil; and/or
d) an emulsifier.

One aspect of the invention relates to a kit for treating a plant that has been damaged by an insect and/or protecting a plant against damage by an insect, the kit comprising:
(a) a composition comprising an aqueous extract of a plant that provides protection against ultraviolet irradiation; and
(b) instructions for carrying out the method of treating the plant and/or protecting the plant against damage by an insect.

The kits of the invention can further comprise other components, such as devices for contacting the plant with the composition and other insecticides, pesticides, and/or herbicides.

The present invention is explained in greater detail in the following non-limiting examples.

### Example 1

### Screening for Plant Extracts Providing UV Protection

The UV protective effects of various plant extracts were tested using a colonized strain of the beet armyworm, Spodoptera exigua (Hübner), established and maintained by U.S. Department of Agriculture-Agricultural Research Service (Tifton, Ga.). Larvae were reared on the Multiple Species diet (Southland Products, Inc., Lake Village, Ak.). The nucleopolyhedrovirus (SeNPV) for S. exigua, registered as Spod-X®, was obtained from Certis USA (Columbia, Md.).

Sixty-six medicinal herbs and spices were obtained from several sources (Foodhild USA, Inc. (Landover, Md.); McCormick & Co. (Hunt Valley, Md.); Natrol (Chatsworth, Calif.); Nature's Herbs (American Fork, Utah); Nature's Resources (Mission Hills, Calif.); Nature's Way Products (Springville, Utah); Sigma-Aldrich Chemicals (St. Louis, Mo.); Solaray (Park City, Utah); Soofer Co. Inc. (Los Angeles, Calif.); Swanson Vitamins (Fargo, N. Dak.); St. John's Herb Garden Inc. (Bowie, Md.); A.L. Verna Co. Inc. (Philadelphia, Pa.); Vitamin Shoppe (N. Bergen, N.J.)) (Table 1). One gram of powder from each plant was blended in 99 grams of distilled water and then filtered through coarse cheesecloth. The filtrates were stored under refrigeration (4° C.) until used.

TABLE 1

| Plant | Scientific Name | Family |
|---|---|---|
| Angelica | Angelica archangelica (Linn.) | Umbelliferae |
| Anise | Pimpinella anisum (Linn.) | Umbelliferae |
| Arrowroot | Maranta membranaceus (Linn.) | Marantacea |
| Astralagus | Astralagus membranaceus (Fisch.) | Leguminosae |
| Basil, sweet | Ocimum basilium (Linn.) | Labiatae |
| Basil, holy | Ocimum sanctum (Linn.) | Labiatae |
| Caraway | Carum carvi (Linn.) | Umbelliferae |
| Catnip | Nepeta cataria Linn. | Labiatae |
| Cayenne | Capsicum minimum (Roxb.) | Solanaceae |
| Celery | Apium graveolens (Linn.) | Umbelliferae |
| Chicory | Cichorium intybus (Linn.) | Compositae |
| Cilantro | Coriandrum sativum (Linn.) | Umbelliferae |
| Cinnamon | Cinnamum zeylanicum (Nees.) | Lauraceae |
| Cloves | Eugenia caryophyllate (Thumb.) | Myrtaceae |
| Cranberry | Vaccinum oxycoccus (Linn.) | Ericeae |
| Cumin | Cuminum cyminum (Linn.) | Umbelliferae |
| Curcumin | Main ingredient of turmeric | |
| Curry | Mixture (cilantro, cumin. Turmeric) | |
| Dandelion | Leontodon taraxacum (Linn.) | Compositae |
| Dill | Peucedanum gravolens (Benth.) | Compositae |
| Eucalyptus | Eucalyptus globulus (Labille) | Myrtaceae |
| Eugenol | Chief constituent of oil of cloves | |
| Fenugreek | Foenus-graecum (Linn.) | Leguminaceae |
| Fennel | Foeniculum vulgare (Gaert.) | Umbelliferae |
| Feverfew | Tanacetum parthenium (Linn.) | Compositae |
| Garlic | Allium sativum (Linn.) | Liliacae |
| Ginger | Zingiber officinale Roscoe | Zingiberaceae |
| Ginseng, Siberian | Eleutherococcus senticosus Maxim | Araliaceae |
| Ginseng, Panax | Panax quinquefolium (Linn.) | Araliacae |
| Goldenseal | Hydrastis canadensis (Linn.) | Ranunculaceae |
| Hawthorn | Crataegus oxyacantha (Linn.) | Rosaceae |
| Horse chestnut | Aesculus hypocastanum (Linn.) | Sapindaceae |
| Juniper | Juniperus communis (Linn.) | Coniferae |
| Kudzu | Pueraria lobata (Wild.) | Fabaceae |
| Lavender | Lavandula angustifolia Stoechas | Labiatae |
| Licorice | Glyrriza glabra (Linn.) | Leguminosae |
| Mace | Myristica fragrans (Houtt.) | Myristicaceae |
| Marjoram | Origanum majorana (Linn.) | Labiatae |
| Magnolia | Magnolia acuminata (Linn.) | Magnoliacae |
| Marshmallow | Althaea officinalis (Linn.) | Malvaceae |
| Mustard | Brassica alba Boiss.) | Cruciferae |
| Noni | Morinda cirtifolia (Linn.) | Rubiaceae |
| Nutmeg | Myristica fragrans (Houtt.) | Myristicaceae |
| Onion | Allium cepa (Linn.) | Liliaceae |
| Oregano | Origanum vulgare (Linn.) | Labiatae |
| Paprika | Capsicum annum (Linn.) | Solanaceae |
| Parsley | Petroselinum crispum (Mill.) | Apiaceae |
| Paw Paw | Asimina triloba (Linn.) | Annonaceae |
| Pepper | Piper nigrum (Linn.) | Piperaceae |
| Peppermint | Mentha piperita (Linn.) | Labiatae |
| Rosemary | Rosmarinus officinalis (Linn.) | Labiatae |
| Radish, wild | Raphanus raphanistrum (Linn.) | Cruciferae |
| Sage | Salvia officinalis (Linn.) | Labiatae |
| Sarasparilla | Smilax glabra (Roxb.) | Liliaceae |
| Saw palmetto | Serenoa glabra (Hook.) | Palmea |
| Skullcap | Scutellaria lateriflora (Linn.) | Labiatae |
| Slippery elm | Ulmus rubra (Muhl.) | Urticaceae |
| Sour grape | Ribes uva-crispa (Linn.) | Ribesiaceae |
| Spearmint | Mentha viridis (Linn.) | Labiatae |
| St. John's wort | Hypericum perforatum (Linn.) | Hypericaceae |
| Sumac | Rhus coriaria (Linn.) | Anacardiaceae |
| Tansy | Tanacetum vulgare (Linn.) | Compositae |
| Tarragon | Artemisia dracunculus (Linn.) | Compositae |
| Thyme | Thymus vulgaris (Linn.) | Labiatae |
| Turmeric | Curcuma longa (Linn.) | Zingiberaceae |
| Valerian | Valeriana officinalis (Linn.) | Valerianaceae |

Radiation was provided by a UVA tube (15 watt, 382 mm, Fotodyne, Inc. (New Berlin, Wis.)) and a UVB tube (15 watt, 382 mm, Fotodyne, Inc. (New Berlin, Wis.)), which were mounted in parallel within a Pelco UV-2 cryo chamber (Ted Pella, Inc. (Redding, Calif.)) 203.2 mm above the test dishes.

Preliminary bioassays were conducted to determine which virus concentration caused 90-95% mortality prior to UV irradiation. As a result of these assays, SeNPV was diluted in distilled water (standard) or in an aqueous plant extract filtrate to obtain a final virus concentration of 1×10⁶ viral inclusion bodies (OB) per ml. Four ml of virus suspension was pipetted into a 60×15 mm glass petri dish (Fisher Scientific (Pittsburg, Pa.)) and was exposed to UVA/UVB irradiation for 30 minutes. After the exposure period, the volume was determined and distilled water was added to each dish to replace water lost by evaporation. Lids were then placed on all dishes, and dishes were stored at 4° C. until used. When dishes were removed from the refrigerator, 0.1 ml of virus suspension (e.g., SeNPV/water and SeNPV/plant extract) was applied to each 30 ml cup containing Multiple Species diet (Southland Products Inc., Lake Village, Ak.) (10 cups per treatment per replicate). In addition, unirradiated SeNPV (1×10⁶ OB/ml; 10 cups per treatment per replicate) was also applied to the cup. Second instars (5 d) were placed individually in each container and were reared for 14 d at 27° C. under ambient conditions. Tests were repeated five times with 10 larvae per treatment, 10 untreated larvae and 10 plant extract-only controls per replicate. Mortality was assessed initially at day 5 and every 2-4 d thereafter until day 14, when the test was terminated. The percentage of original activity remaining (OAR) post UV-irradiation was used as the basis of UV protection and was based upon virus-caused mortality before and after irradiation (Ignoffo et al., J. Econ. Entomol. 64:850 (1971); Ignoffo et al., Environ. Entomol. 6:411 (1977)).

Irradiation of an aqueous suspension of SeNPV for 30 min reduced NPV-caused mortality from 97.3% to 7.8% (=8.0% OAR). Of the 66 SeNPV/plant extract combinations exposed to UVA/UVB (30 min), 46 extracts (60.9%) provided good to excellent UV protection. Nineteen extracts (28.8%) provided good UV protection (i.e., 70-89% OAR) and 27 (40.9%) provided excellent UV protection (at least 90% OAR) (Table 2). Those extracts that provided at least 90% UV protection were chosen for the next screen.

TABLE 2^{A}

| Percent Original | |
|---|---|
| Activity Remaining^{b} | Extract |
| 0-9.9 | Arrowroot (1) |
| 10-29.9 | Chicory (1) |
| 30-49.9 | Dandelion, Ginseng (Panax, Siberian), |
| | Goldenseal, Juniper, Marshmallow, Noni |
| | (Hawaiian), Slippery elm, Sour grape, Turmeric |
| | (10) |
| 50-69.9 | Cayenne, Celery, Cranberry, Garlic, Mustard, |
| | Nutmeg, Parsley, Saw Palmetto (8) |
| 70-89.9 | Angelica, Basil (Holy, Sweet), Caraway, Catnip, |
| | Cumin, Curcumin, Curry, Eucalyptus, Fennel, |
| | Ginger, Hawthorn, Horse Chestnut, Mace, Paw |
| | Paw, Pepper, Radish (wild), Sarsaparilla, Tansy |
| | (19) |
| 90->99.0 | Anise, Astralagus, Cilantro, Cinnamon, Cloves, |
| | Dill, Fenugreek, Feverfew (capsules, leaves), |
| | Kudzu, Licorice, Magnolia, Marjoram, Oregano, |
| | Paprika, Peppermint, Popcorn tree (leaves, seeds), |
| | Rosemary, Sage, Spearmint, Skullcap, St. John's |
| | wort, Sumac, Tarragon, Thyme, Valerian (27) |

^{a}NPV was used at final concentration of 72.0 OB/mm² of diet surface. Five replicates; 10 larvae per treatment per replicate; 10 untreated control per replicate; 10 plant extract-exposed larvae per replicate. Virus was exposed to UVA/UVB irradiation in deionized water (standard) or in plant extract (1% wt:wt).
^{b}For % original activity remaining (OAR), all treatments were compared to NPV/H₂O (0 UV), where NPV/H₂O = 100% OAR. In this test, control mortality = 0.0%; NPV/H₂O (0 UV) = 97.3%; NPV/H₂O (30 min UV) = 9.8%.

### Example 2

### Secondary Screening for Plant Extracts providing UV Protection

As a result of the primary screen, those plant extracts that provided 90->99% OAR were selected for the secondary screen. In this test, two UVB tubes were used instead of the UVA/UVB combination, since the UVB/UVB system emitted more radiation during the 30 minute irradiation exposure. The protocol for this test was the same as the UVA/UVB primary screen and tests were repeated five times.

Irradiation of an aqueous suspension of SeNPV for 30 min under two UVB tubes reduced NPV-caused mortality from 96.7% to 3.3% (3.4% OAR). The 27 SeNPV/plant extract combinations identified in Example 1 were exposed to UVB/UVB (30 min) and 24 extracts (88.9%) provided good to excellent (70->99% OAR) UV protection. Nine extracts (33.3%) provided good protection (70-89% OAR) and 15 (55.6%) provided excellent UV protection (at least 90% OAR) (Table 3). Those extracts that provided at least 90% OAR were chosen for the final screen.

TABLE 3^{A}

| Percentage original | |
|---|---|
| activity remaining^{b} | Extract |
| 0-9.9 | Sumac (1) |
| 10-29.9 | St. John's wort (1) |
| 30-49.9 | |
| 50-69.9 | Astragalus (1) |
| 70-89.9 | Anise, Cilantro, Cinnamon, Feverfew |
| | (capsules), Paprika, Popcorn tree (leaves, |
| | seeds), Sage, Valerian (9) |
| 90->99.0 | Cloves, Dill, Fenugreek, Feverfew (leaves), |
| | Kudzu, Licorice, Magnolia, Marjoram, |
| | Oregano, Peppermint, Rosemary, Skullcap, |
| | Spearmint, Tarragon, Thyme (15) |

^{a}NPV was used at final concentration of 72.0 OB/mm² of diet surface. Five replicates; 10 larvae per treatment per replicate; 10 untreated control larvae per replicate; 10 plant extract-exposed larvae per replicate. Virus was exposed to UVB/UVB irradiation in deionized water (standard) or in plant extract (1% wt:wt) for 30 minutes.
^{b}For % original activity remaining (OAR), all treatments were compared to NPV/H₂O (0 UV), where NPV/H₂O = 100% OAR. In this test, control mortality = 0.0%; NPV/H₂O (0 UV) = 96.7%; NPV/H₂O (30 min UV) = 3.3%.

### Example 3

### Tertiary Screening for Plant Extracts providing UV Protection

As a result of the secondary screen, those plant extracts that provided 90->99% OAR were selected for the final screen. In this test SeNPV/H₂O and SeNPV/plant extract were exposed to UVB/UVB irradiation for 300 minutes. The test was repeated five times.

Irradiation of an aqueous suspension of SeNPV for 300 min reduced NPV-caused mortality from 97.0% to 0.7% (0.7% OAR). The 15 SeNPV/plant extract combinations identified in Example 2 were exposed to UVB/UVB (300 min). Ten extracts (66.7%) provided good to excellent UV protection (70->99% OAR). Seven extracts (46.7%) provided good protection (70-89.9% OAR) and three (20.0%) provided excellent UV protection (at least 90% OAR) (Table 4). These three plants extracts (kudzu, peppermint, skullcap) represent 4.5% of the 66 extracts, following UVA/UVB (30 min), UVB/UVB (30 min) and UVB/UVB (300 min) irradiation regimens.

TABLE 4^{A}

| Percentage | |
|---|---|
| original activity remaining^{b} | Extract |
| 0-9.9 | Dill (1) |
| 10-29.9 | Fenugreek, Feverfew (leaves) (2) |
| 30-49.9 | Licorice, Magnolia (2) |
| 50-69.9 | |
| 70-89.9 | Cloves, Marjoram, Oregano, Rosemary, |
| | Spearmint, Taragon, Thyme (7) |
| 90->99.0 | Kudzu, Peppermint, Skullcap (3) |

^{a}NPV was used at final concentration of 72.0 OB/mm² of diet surface. Five replicates; 10 larvae per treatment per replicate; 10 untreated control larvae per replicate; 10 plant extract-exposed larvae per treatment. Virus was exposed to UVB/UVB irradiation in deionized water (standard) or in plant extract (1% wt:wt) for 300 minutes.
^{b}For % original activity remaining (OAR), all treatments were compared to NPV/H₂O (0 UV) where NPV/H₂O = 100% OAR. In this test, control mortality = 0%; NPV/H₂O (0 UV) = 97.%; NPV/H₂0 (300 min UV) = 0.7%).

### Example 4

### Ultraviolet Absorption of Plant Extracts

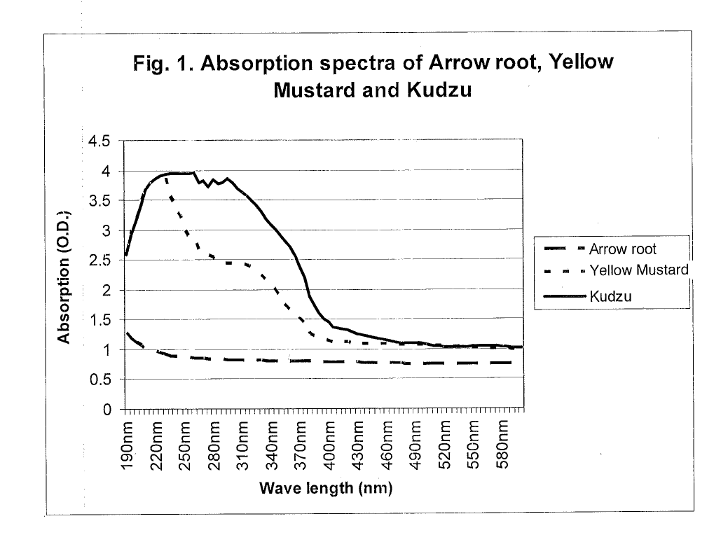

Aqueous extracts of kudzu, arrow root, and yellow mustard as described above were tested for ability to absorb light at various wavelengths using a spectrophotometer. As shown in FIG. 1, the kudzu and yellow mustard extracts exhibited substantial absorption in the ultraviolet range (<400 nm), with kudzu exhibiting the highest absorbance. Arrow root exhibited minimal absorption at these wavelengths. These data confirm the results obtained from the screening assay, which showed that kudzu had the highest protective effect, while mustard had an intermediate level of activity and arrow root exhibited little activity.

### Example 5

### Field Studies of Plant Extracts

Several plant extracts were field tested for their ability to protect insect virus (SeNPV) from UV radiation. The field work was carried out by spraying the various materials (5% wt:wt aqueous extracts) on collard plants and collecting the leaves at various times (days) after application of the spray beginning at day one. Collected leaves were placed in the refrigerator until ready to be tested. The leaves were taken from the refrigerator and a small disc was taken from each leaf using a hole punch. The leaf disc was presented to caterpillars (Beet Armyworms, Spodoptera exigua) which were allowed to feed for 48 hours. After this time the caterpillars had consumed the entire disc. After the caterpillars consumed the leaf discs, they were transferred to small 1 oz cups containing artificial diet. At the end of about 10 days (sufficient time for the insect virus to act), the dead and live caterpillars were counted. The results are shown in Table 5. The data in each column are percent mortality of the Beet Armyworm larvae. Oil refers to cottonseed oil. Treatments with “mix” means that cottonseed oil (8% wt:vol extract:oil) was added to the formulation. The results show that virus alone (in the absence of plant extract or oil) lost the ability to kill the larvae after two days of exposure to light. In the presence of cottonseed oil, the virus induced 6.89% mortality after seven days. Black tea extract was similar to oil alone, while kudzu extract (24.14% mortality after 7 days) and Marasperse CBOS-4 (Borregaard LignoTech, a lignosulfonic acid; 20.69% mortality after 7 days) exhibited significant protective affects. Mixing cottonseed oil with plant extract provided an additive protective effect for black tea and an apparent synergistic protective effect with kudzu (46.66% mortality after 7 days). However, mixing oil with the lignin actually decreased the protective effect of the lignin. Thus, plant extracts such as kudzu that exhibit UV absorption properties are effective to provide UV protection to insect microbial agents under field conditions. The addition of an oil to the extract enhances the protective effect.

TABLE 5

| | Virus | | | | | Kudzu | Black tea | Marasperse |
|---|---|---|---|---|---|---|---|---|
| | Alone | Oil | Kudzu | Black tea | Marasperse | Mix | Mix | Mix |
| D zero | 100 | 100 | 100 | 100 | 100 | 100 | 100 | 100 |
| D1 | 86.66 | 85.71 | 89.65 | 93.33 | 89.65 | 100 | 96.55 | 100 |
| D2 | 41.37 | 29.62 | 79.31 | 58.62 | 56.66 | 100 | 63.33 | 58.62 |
| D4 | 0 | 14.81 | 51.72 | 23.33 | 31.03 | 60 | 34.62 | 43.33 |
| D7 | 0 | 6.89 | 24.14 | 6.66 | 20.69 | 46.66 | 17.24 | 3.33 |

The foregoing is illustrative of the present invention, and is not to be construed as limiting thereof. The invention is defined by the following claims, with equivalents of the claims to be included therein. All publications, patent applications, patents, patent publications, and any other references cited herein are incorporated by reference in their entireties for the teachings relevant to the sentence and/or paragraph in which the reference is presented.

What is claimed is:

1. A method of protecting an insect microbial agent against damage by ultraviolet irradiation, comprising contacting the insect microbial agent with an effective amount of a composition comprising an extract of a plant selected from the group consisting of anise, astralagus, cilantro, cinnamon, cloves, dill, fenugreek, feverfew, kudzu, licorice, magnolia, marjoram, oregano, paprika, peppermint, popcorn tree, rosemary, sage, spearmint, skullcap, St. John's wort, sumac, tarragon, thyme, valerian, and any combination thereof.

2. The method of claim 1, wherein the plant is selected from the group consisting of cloves, dill, fenugreek, feverfew, kudzu, licorice, magnolia, marjoram, oregano, peppermint, rosemary, skullcap, spearmint, tarragon, thyme, and any combination thereof.

3. The method of claim 1, wherein the plant is selected from the group consisting of kudzu, peppermint, skullcap, and any combination thereof.

4. The method of claim 1, wherein the extract is an aqueous extract.

5. The method of claim 1, wherein the composition further comprises an oil.

6. The method of claim 1, wherein the composition further comprises an emulsifier.

7. The method of claim 1, wherein the insect microbial agent is an insect virus.

8. The method of claim 7, wherein the insect virus is a baculovirus selected from the group consisting of Spodoptera exigua nucleopolyhedrovirus, Spodoptera frugiperda nucleopolyhedrovirus, Spodoptera littoralis nucleopolyhedro virus, Spodoptera litura nucleopolyhedrovirus, Lymantria dispar nucleopolyhedrovirus, Helicoverpa zea nucleopolyhedrovirus, Helicoverpa armigera nucleopolyhedrovirus, Helicoverpa virescens nucleopolyhedrovirus, Anagrapha falciferct nucleopolyhedrovirus, Autographa californica nucleopolyhedrovirus, Cydia pomonella granulosis virus, Mamestra brassicae nucleopolyhedrovirus, Plutella xylostella granulosis virus, and any combination thereof.

9. The method of claim 1, wherein the insect microbial agent is a bacterium.

10. The method of claim 9, wherein the bacterium is Bacillus thuringiensis.

11. The method of claim 1, wherein the insect microbial agent is a fungus.

12. The method of claim 11, wherein the fungus is Beauveria bassiana or Metarizium anisopliae.

13. The method of claim 1, wherein the insect microbial agent is a botanical.

14. The method of claim 13, wherein the botanical is Azadirachta indica.

15. The method of claim 1, wherein the insect microbial agent is a microbial product.

16. The method of claim 15, wherein the microbial product is spintor.

17. The method of claim 1, wherein the insect microbial agent is a nematode.

18. The method of claim 17, wherein the nematode is a Steinernema or Heterorhabditis species.

19. A composition for protecting an insect microbial agent against damage by ultraviolet irradiation, said composition comprising:
a) an aqueous extract of a plant selected from the group consisting of anise, astralagus, cilantro, cinnamon, cloves, dill, fenugreek, feverfew, kudzu, licorice, magnolia, marjoram, oregano, paprika, peppermint, popcorn tree, rosemary, sage, spearmint, skullcap, St. John's wort, sumac, tarragon, thyme, valerian, and any combination thereof;
b) an oil; and
c) an emulsifier.

20. The composition of claim 19, comprising about 1% to about 30% aqueous extract (vol/vol).

21. The composition of claim 19, comprising about 1% to about 15% oil (vol/vol).

22. The composition of claim 19, comprising about 1% to about 5% emulsifier (vol/vol).

23. A protected insect microbial agent composition, comprising:
a) an insect microbial agent;
b) an aqueous extract of a plant selected from the group consisting of anise, astralagus, cilantro, cinnamon, cloves, dill, fenugreek, feverfew, kudzu, licorice, magnolia, marjoram, oregano, paprika, peppermint, popcorn tree, rosemary, sage, spearmint, skullcap, St. John's wort, sumac, tarragon, thyme, valerian, and any combination thereof;
c) an oil; and
d) an emulsifier.

24. A method of treating a plant that has been damaged by an insect and/or protecting a plant against damage by an insect, comprising contacting the plant with the composition of claim 23.

25. A kit for treating a plant that has been damaged by an insect and/or protecting a plant against damage by an insect, the kit comprising:
(a) a composition comprising an aqueous extract of a plant selected from the group consisting of anise, astralagus, cilantro, cinnamon, cloves, dill, fenugreek, feverfew, kudzu, licorice, magnolia, marjoram, oregano, paprika, peppermint, popcorn tree, rosemary, sage, spearmint, skullcap, St. John's wort, sumac, tarragon, thyme, valerian, and any combination thereof; and
(b) instructions for carrying out the method of treating the plant and/or protecting the plant against damage by an insect.
